(19) United States
(12) Patent Application Publication
(10) Pub. No.: US 2002/0034288 A1
(43) Pub. Date: Mar. 21, 2002

(54) Method of providing a diary management sevice and also a server, subscriber switching center and terminal therefor

(75) Inventors: Frank Hagebarth, Kirchheim (DE); Elke Schweizer, Leinfelden (DE)

Correspondence Address: SUGHRUE, MION, ZINN,, MACPEAK & SEAS, PLLC, 2100 Pennsylvania Avenue, N.W., Washingon, DC, 20037-3213, US

(73) Assignee: ALCATEL

(21) Appl. No.: 09/948,636

(22) Filed: Sep. 10, 2001

(30) Foreign Application Priority Data
Sep. 16, 2000 (DE) 100 45 896.3

(51) Int. Cl. H04M 3/42

(52) U.S. Cl. 379/202.01

(57) ABSTRACT

The invention relates to a method of providing a diary management service for a called subscriber of a communications network, in which the appointment management takes place by means of a (personal) electronic diary, comprising the steps of defining each particular time interval in the diary for various types of communication, in particular for telephone calls, telephone conferences, video conferences or personal meetings, and storing said information in a (personal) communication mask, reception of a communication request with the specification of a time request or of a desired type of communication of a calling terminal in the electronic diary, determination of one or more possible appointments for the communication request and communication to the calling terminal, reception of a confirmation of the acceptance of an appointment by the calling terminal and storage of said terminal, and also to a server, a subscriber switching centre and a terminal therefor.

### BACKGROUND OF THE INVENTION

The invention is based on a priority application DE 100 45 896.3 which is hereby incorporated by reference. The invention relates to a method of providing a diary management service for a communications network subscriber, in which the appointments management takes place by means of a (personal) electronic diary by performing the following steps:

definition of particular time intervals in the electronic diary for various types of communication, in particular for telephone calls, telephone conferences, video conferences or personal meetings, and storage of said information in a (personal) communication mask,

reception of a communication request with the specification of a time request or a desired type of communication of a calling (subscriber) terminal in the electronic diary,

determination of one or more possible appointments for the communication request and transmission to the calling terminal,

reception of a confirmation of the acceptance of an appointment by the calling terminal, and

storage of said appointment and also to a server, a subscriber-switching device and a subscriber terminal.

The management of a daily schedule, for example in regard to telephone calls, telephone conferences, video conferences, personal meetings or conferences involving a plurality of participants, requires extensive appointment arrangements. In this connection, appointment clashes frequently occur. Eliminating the latter is associated with appreciable time consumption and working effort, in particular if a manned secretarial service is not available for these tasks. Synchronous communication is of particular importance in this connection. A continuous workflow is not possible if interruptions are repeatedly imposed by a telephone constantly ringing.

Known so-called groupware solutions, such as Lotus Notes, promote communication within working groups. This solution is, however, possible only within companies and if the employees are equipped with appropriate hardware and software. In addition, on-line appointment books available on the Internet or in-house Intranet are known for the purpose of clear appointment scheduling and management. For example, the Internet calendar of the Internet service provider YAHOO has become very well known. However, said on-line appointment books are accessible only by means of appropriate Internet terminals. In addition, said on-line appointment books do not have a link-up to existing telephone networks.

### SUMMARY OF THE INVENTION

The object of the invention is to provide a method and means for increasing the efficiency of communication inside and outside companies.

The object is achieved by a method of providing a diary management service for a communications network subscriber, in which the appointments management takes place by means of a (personal) electronic diary and also by a server having an electronic diary and connection means for making a communication connection with a calling subscriber, a subscriber-switching centre or a terminal having an electronic diary.

The diary management service is a type of electronic secretarial service and manages, in particular, an employee's meeting appointments, there being no limitation to individual forms of communication. A subscriber specifies by means of personal communication masks time windows at which he is available for certain types of communication. The communication mask is stipulated by the user via a suitable terminal. In this connection, the communication mask may be stored either in the terminal itself or in a server that is called by means of a suitable terminal. The user is shown his personal calendar by means of a user interface, preferably graphic. Said calendar is subdivided into a plurality of regions, days of a week or hours of a day, in particular, being displayed. In the calendar regions, it is possible to specify in a suitable manner time intervals for various types of communication. These may be, for example, telephone calls, telephone conferences, video conferences, personal meetings or conferences with more than two participants. Thus, the user may stipulate, for example, that he is available daily except Saturday and Sunday from 9.00 to 11.00 for incoming telephone calls, or that he receives visitors or can participate in conferences on a certain day from 13.00 to 18.00.

In a further version, the user can stipulate for certain time windows that certain actions are to be performed or certain information communicated to calling subscribers. He can also specify certain options to be communicated to the callers for certain time windows.

### BRIEF DESCRIPTION OF THE DRAWINGS

Advantageous developments are described in greater detail below by reference to an exemplary embodiment.

The term subscriber will be used below both for an individual participating in the method described and for the terminal used by the individual.

A (subscriber) A communicates with a (subscriber) B. In this example, B has an electronic secretarial service.

B installs a communication mask for incoming telephone calls. The mask defines time windows in which a daily time window is provided from 9.00 to 11.00. Within said time window, subscriber B accepts telephone calls. Outside said time, incoming calls are to be switched to an announcement having a voice menu. The voice menu should make it possible, in urgent cases, for the caller to be able nevertheless to initiate an immediate call to subscriber B.

A dials the telephone number of B on his telephone around 17.00.

The telecommunication system to which B is connected automatically switches the incoming call to a recorded announcement device. Said recorded announcement device informs the caller A that B does not wish to be disturbed at present.

In addition, the recorded announcement device announces that B has an electronic secretarial service via which information can be obtained about favourable times in accordance with the communication mask. The announcement may also announce how appointments can be organized for conferences.

The recorded announcement device provides information about the possible alternatives to A's further procedure:

1. A can replace the receiver and make contact with the electronic secretarial service, via a suitable terminal, for example a personal computer.

2. By selecting a certain digit on his telephone, A can initiate a direct call to subscriber B in an urgent case.

3. By selecting another digit, A can listen to an announcement that communicates to him the time window for the reception of telephone calls by B.

4. If A has a terminal that permits it, he can make a connection directly to the electronic secretarial service, for example by selecting a certain digit. Preferably, a terminal with WAP facility is suitable for this purpose.

The selection of one of the options that are offered by means of the recorded announcement device may take place by key selection or under voice control.

If A is connected to the electronic secretarial service of B, a menu appears on the display of his terminal via which, in particular, the following options can be selected:

the desired type of communication, namely a telephone call, a telephone conference, a video conference, a personal meeting, a conference involving a plurality of participants or another type of communication,

the desired point in time, namely as soon as possible, today at . . . o'clock, tomorrow, in . . . days, this week, this month or another point in time,

the expected time duration of the communication, namely 5 minutes, 10 minutes, 30 minutes, 1 hour, . . . hours, 1 day or another time duration, and

the reason for the communication request.

Some of these selection possibilities require additional data, namely, in particular, location specifications, if a personal meeting or a conference is to take place at a particular location.

After the desired options have been selected and additional items of information have been inputted, these data are forwarded to a program that is situated on a server on the Internet or Intranet. Said program has access to a data bank that stores B's appointment schedule.

Taking account of the installed communication masks, the program determines at least one possible point in time for the desired communication and initiates the display of these items of information on the display of A's terminal.

A confirms the appointment or chooses an appointment from the proposed appointments. He can also decline the proposed appointments. In that case, the program will search for an alternative appointment.

A terminates the connection to B's electronic secretarial service.

If the agreed type of communication is electronic communication, the parameters of the telecommunication system are transmitted that initiate the setting up of a connection at the agreed point in time.

The recorded announcement device may also inform the subscriber of an Internet address (URL) via which the electronic secretarial service can be reached on the in-house Intranet or on the Internet.

The service described is also suitable for managing conference rooms, for lending equipment or for other management tasks. A use in the private sector is also conceivable. This is the case, for example, if a subscriber can never be reached by telephone every Thursday from 19.00 to 22.00 because he usually goes to bowling in that time interval. He therefore installs a communication mask. During the time window from 19.00 to 22.00, the latter always initiates an action on Thursday that switches every incoming call to an announcement. The announcement comprises a voice menu in which the caller can select whether he would like to leave a message or whether his call should be diverted directly to the bowling premises.

The owner of an on-line appointment book manages the latter via a web page on the Intranet or Internet which he accesses with a suitable terminal, for example a PC, a screen phone, a mobile-radio with WAP capability or an organizer with WAP capability. He can obtain up-to-date information on all the appointments made, confirm or cancel certain appointments or add, change or cancel his own appointments. He is automatically informed shortly before the beginning of all imminent appointments, provided that an electronic type of communication is not involved. This may take place, for example, by means of a short message service (SMS) transmission to his mobile telephone, by a call with a suitable announcement or by an e-mail. If an appointment already made is cancelled or changed, the communication partner affected is automatically informed. This can again take place by means of a short messages service (SMS) transmission, by telephone calls with a suitable announcement or by e-mail.

The communication masks and the appointment management functions do not necessarily have to be stored in a server. They may also be available to the connected subscribers as an independent performance feature of a subscriber-switching device. It is also conceivable to incorporate the appropriate functions in a terminal. Optionally, appropriate instructions to perform the actions envisaged can be given, for example, to the switching device at the beginning or at the end of particular time windows. In this way, for example, a call diversion, an announcement or even certain appointment management functions can be implemented.

The invention is not limited to the exemplary embodiment specified above. On the contrary, a number of variants is conceivable which comprise the basic idea of the invention.

1. Method of providing a diary management service for a communications network subscriber, in which the appointments management takes place by means of a (personal) electronic diary by performing the following steps:
definition of particular time intervals in the electronic diary for various types of communication, in particular for telephone calls, telephone conferences, video conferences or personal meetings, and storage of said information in a (personal) communication mask,
reception of a communication request with the specification of a time request or a desired type of communication of a calling (subscriber) terminal in the electronic diary,
determination of one or more possible appointments for the communication request and transmission to the calling terminal,
reception of a confirmation of the acceptance of an appointment by the calling terminal, and
storage of said appointment.

2. Method according to claim 1, to determine one or more possible appointments, the data of the communication request being compared with the state of reservation of the time window envisaged for the desired type of communication and a confirmation of the communication request or an alternative appointment proposal is communicated to the calling terminal.

3. Method according to claim 1, the agreed type of communication being an electronic type of communication, the setting up of an appropriate communication connection is automatically initiated at the agreed point in time.

4. Method according to claim 1, a terminal of the called subscriber being informed of the stored appointments.

5. Method according to claim 1, the communication mask containing the information that, depending on certain events or states, in particular the call time or a selection of the calling subscriber from a menu, a call directed to the called subscriber by the calling subscriber is either to be put through directly or a connection is to be made to a device for providing the appointments management service.

6. Method according to claim 1, the called subscriber being able to access his electronic diary by means of a terminal with WAP capability or by means of an Internet terminal.

7. Method according to claim 1, the calling subscriber offering preset selection possibilities, in particular in regard to the type of communication, the desired point in time, the time duration to be planned in, the reason for the communication request and, optionally, the location, if a personal meeting is chosen as the type of communication.

8. Server having an electronic diary and connection means for making a communication connection with a calling subscriber for performing the following steps:
storage of a communication mask with allocation of each particular time interval in the appointment calendar to various types of communication,
reception of a communication request with the specification of a time request or a desired type of communication of the calling terminal,
determination of one or more possible appointments for the communication request and transmission to the calling terminal,
receipt of a confirmation of the acceptance of an appointment by the calling terminal and
storage of said appointment.

9. Server according to claim 8, access means being present for reading or processing the electronic diary and the communication mask of the called terminal.

10. Server according to claim 8, instruction means being present for instructing a subscriber switching device to initiate certain actions specified in the communication mask.

11. Subscriber switching device having an integrated server according to claim 8.

12. Subscriber terminal having an electronic diary for providing a diary management service, comprising means for performing the following steps:
definition in each case of particular time intervals in the diary for various types of communication and storage of said information in a (personal) communication mask,
reception of a communication request with the specification of a time request or of a desired type of communication of a calling terminal,
determination of one or more possible appointments for the communication request and transmission to the calling terminal,
reception of a confirmation of the acceptance of an appointment by the calling terminal and
storage of said appointment.
